(19) United States
(12) Patent Application Publication
(10) Pub. No.: US 2007/0259793 A1
(43) Pub. Date: Nov. 8, 2007

(54) Activated silicon-containing-aluminum complex soil detoxification and method of preparation thereof

(76) Inventor: Matthew Feller, Tenafly, NJ (US)

Correspondence Address: Matthew Feller, Suite 1c, 2150 Center Ave, Fort Lee, NJ, 07024, US

(21) Appl. No.: 11/649,875

(22) Filed: Jan. 5, 2007

Related U.S. Application Data
(63) Continuation-in-part of application No. 11/488,169, filed on Jul. 14, 2006.
Application No. 11/488,169 is a continuation-in-part of application No. 11/417,306, filed on May 3, 2006.

(51) Int. Cl. C11D 1/00

(52) U.S. Cl. 510/109

(57) ABSTRACT

The usefulness of the complex of the present invention will extend virtually to any application where soil decontamination of toxic substances would be advantageous. The complex of this invention is capable to break down the composition of most toxic contaminating materials, so that they separate into basic atomic stage and rendering them inactive, therefore in the contaminating soil. Moreover the subject complex is nonpolluting, nontoxic and safe environmentally, having no adverse impact of any kind in the atmosphere, soil or water. It is noncorrosive as well.

### CROSS REFERENCE TO RELATED APPLICATIONS

This application is related to Fred B. Bernats' U.S. application Ser. No. 312,572 filed Oct. 19, 1981, now abandoned, and to the U.S. Pat. No. 4,548,841 Oct. 22, 1985, now abandoned.

This application is related to Fred B. Bernats' U.S. patent Ser. No. 275,801 filed Jun. 22, 1981 for: Activated Silicon-Containing-Aluminum complex and method of preparation thereof.

### RELATED U.S. APPLICATIONS DATA

| Continuation of Ser. No. 312512 | Oct. 19, 1981 Now abandoned |
|---|---|
| Continuation of Ser. No. 548841 | Oct. 22, 1985 Now abandoned |
| Int. Cl. | C09D5/14 |
| U.S. Cl | 427/372.2; 106/15.05; 106/18.12; |
| | 106/18.26; 427/397/7; 427/439 |
| Field of Search | 106/15.05; 18.12, 18.26 |
| | 427/383.1; 397.77 439.3 72.2 |

### REFERENCE CITED—S.S. DOCUMENTS

| | | | |
|---|---|---|---|
| 4,247,410 | January, 1981 | Bernat | 252/305 |
| 4,277,355 | January, 1981 | Farcnik | 106/15.05 |
| 4,382,025 | May, 1983 | Sallay | 106/15.05 |
| 3,957,598 | May, 1976 | Merkl | 18/12 |
| 3,856,841 | December, 1974 | Merkl | 18/26 |
| 3,578,439 | May, 1971 | Merriman | 106/18.12 |

### STATUS OF THE INVENTION

This invention is a continuation in part of the patent application of Matthew Fellers' No. 11/488,169 of Jul. 14, 2006 now pending and of the patent application of Matthew Fellers' No. 11/417,306 of May 3, 2006 now pending

### BACKGROUND OF THE INVENTION

In the patent Ser. Nos. 795,115 and 810,103, it is stated that the structure of aluminum can be changed by chemical and electrochemical attack. The cylindrical or spherical shape of the silicon trace material was found to change to hexagonal shape as a consequence of attack by the “free chlorine” of the slurry when such was applied to an ordinary aluminum foil (U.S. Pat. No. 795,115). It is believed that the same change in structure occurs in the silicon particles contained in the aluminum particles suspended in the slurry with the hydrochloric acid solution. This change in structure which can be observed in the finished oxygenated solid fuel (U.S. Pat. No. 810,103) is also believed to be significant i.e. it furnishes some understanding of what has and does take place which enables the subject composition to function beside as a flame proofing agent, also as a regular toxics contaminated soils' decontaminating agent.

It should be noted that when ordinary aluminum is introduced into an HCL solution, e.g. 1 N or 2N the production of aluminum chloride and water occurs, however, the mercury treated aluminum in this invention acts very differently. There is still the formation of AlCl₃ and other aluminum compounds as well, when such is immersed in the HCL solution. However after the passage of from 8-72 hours a slurry is formed starting as a faint white cloud. This is a consequence of “growth” on the “treated” aluminum, which growth then “falls off” in to the acid bath and begins to form the slurry. After the passage of about 8 hours or so, the slurry is in full “bloom” and a discernible increase beings to occur, leading to the preferred viscosity range of 12,000-16,000 CPS.

In this slurry, a relatively small mount weight wise, of activated aluminum growth particles is suspended perhaps as a colloid. As stated previously, the percentage of the same is between about 0.7-1.5% by weight. These “growth” particles, however, now contain entrapped therein because of their clathrate properties “free chlorine” (from the HCL), oxygen and hydrogen probably in molecular or ionic form. The silicon particles of the aluminum have also been changed to the hexagonal structure.

Thus the slurry at least contains:

The reaction product of aluminum and hydrochloric acid in solution e.g. Al³⁺Cl⁻H⁺OH⁻ ions.

Free “activated” aluminum suspended probably as a colloid, containing hexagonally structured silicon and also additionally containing traces of chlorine, hydrogen and oxygen entrapped therein.

The unusual properties of the slurry may possibly be explainable as a consequence of “Van Der Waals forces”, of the well known ability of particles in a colloidal suspension to attract and retain on their surfaces dissolved substances and solvent molecules i.e. to have molecules present in the solution even in ionic form become entrapped in or adherent to the particulate matter of the slurry or colloid. Whatever is the explanation of the slurry, it is a critical medium for decontamination of the toxic substances in the contaminated soil.

### BRIEF SUMMARY OF THE INVENTION

The usefulness of the complex of the present invention will extend virtually to any application where soil decontamination of toxic substances would be advantageous. The complex of this invention is capable to break down the composition of most toxic contaminating materials, so that they separate into basic atomic stage and rendering them inactive therefore in the contaminating soil.

Moreover the subject complex is nonpolluting, nontoxic and safe environmentally having no adverse impact of any kind in the atmosphere, soil or water. It is noncorrosive as well.

### BRIEF DESCRIPTION OF THE SEVERAL VIEWS OF THE DRAWING

FIG. 1 is a schematic sectional elevational view of one embodiment of stage 1 of the process of the present invention

FIG. 2 is a schematic view similar to FIG. 1 showing another optional embodiment of stage 1 process of this invention.

FIG. 3 is a schematic view similar to FIG. 1 showing the formation of the slurry in the HCL bath in stage two of the process of the present invention. In this embodiment, the aluminum is disposed substantially equidistant from the sides and bottom of the vessel.

FIG. 4 is a depiction of the structure of the untreated, inactive silicon found in inactivated form in the aluminum.

FIG. 5 is a depiction of the hexagonal structure of the silicon of the complex formed in the stages two and three of the process of the present invention in the slurry.

### DETAILED DESCRIPTION OF THE INVENTION

The activated silicon containing complex of this invention can be conveniently prepared, utilizing a six stage process, although the process is not to be narrowly construed as being limited to such. The first stage, the preparation of a form of aluminum which can be termed “phase one” can typically be carried out as follows:

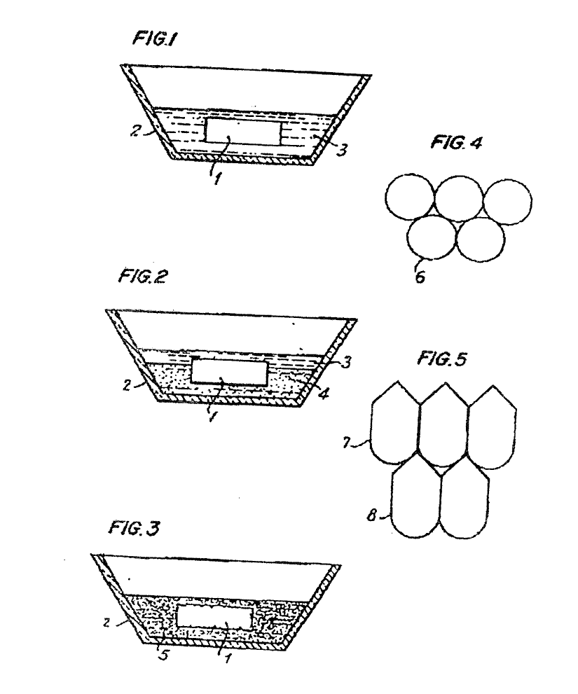

Utilizing the apparatus of FIG. 1 and aluminum bar or rod(1) is placed as shown in a vessel(2), the latter preferably of glass and a thin layer of hydrochloric acid (3) is placed slightly, covering the aluminum. In this context the shape of the aluminum is not narrowly critical. However, a bar or rod shape is generally preferred. The purpose of the acid treatment is to inhibit the formation of oxide on the aluminum surface. HCL is usually the acid employed for this purpose.

It is further important that the aluminum be substantially pure, on the order of, but not limited to, about 99.94% pure and also contain amounts of silicon on the order of trade about 60-150 ppm. As a practical matter, whether the aluminum is sufficiently pure can be empirically determined since, if there is an abrupt rise in temperature the indicates oxide formation and that the aluminum starting material was not sufficiently pure. Therefore the purpose of this application, the term substantially pure aluminum denotes that degree of purity which is empirically determinable to be capable of being used in the process of this invention.

The aluminum is then contacted or coated with mercury, preferably placing such in a bath of the same in a similar type apparatus, in the presence of any oxygen-gas-containing atmosphere, such as air. In either of these preliminary steps, the temperature is not narrowly critical, but should not be such as to encourage oxide formation and/or chlorine gas. Ambient temperature is satisfactory.

If desired, the acid and mercury contact can be made simultaneously as shown in FIG. 2. In this figure the aluminum (1) is immersed in the acid bath (3) and the heavier mercury bath (4), the HCL forming a layer on the bath of mercury, whether the apparatus on FIG. 1 or 2 or other suitable apparatus is used, the length of time of contact with the mercury can be minimal on the order of between fifteen and thirty seconds, longer contact however is not detrimental within the context of this invention, the mercury acts only as a catalyst, which effects a change in the aluminum structure. As indicated about this changed structure is “phase one”

The formation of “phase two” is the second stage in the process of this invention. This stage involves the formation of a slurry comprising phase one immersed in an acidic solution containing halogen. Particularly preferred among the suitable halogen solution is hydrochloric acid.

The slurry can be formed in a number of ways and the method thereof is not critical in and of itself. For example, after contact with the mercury bath, the thus-treated aluminum rod or bar is then immersed in another vessel, containing a bath of HCL. The latter should have a normality of about 1 Normal to about 2 Normal, but the actual range of concentration is empirical. When phase one, which is soluble in HCL to some extent is immersed in the acid solution, a rather viscous slurry white in color is formed. The slurry begins as a cloudy suspension and becomes increasingly dense. This is the consequence of particulate growth in and on the mercury treated and activate aluminum rod or bar of phase on. This growth is shown in FIG. 3, wherein the thick slurry (5) is denoted as forming in the acid bath. As more and more particles form, the slurry becomes more and more viscous.

Depending on the size of the aluminum bar or the amount of HCL present, the formation of the slurry can continue up to the entire consummation of the phase one aluminum material. However as a practical matter, the reaction will usually stop before the aluminum bar is consumed completely because the slurry will become too dense for further growth to occur. At this point, the thick slurry thus formed can be removed, partly or completely; additional HCL is then added and slurry formation continued. As a practical matter, the viscosity of the slurry can be as low as 10,000 cps. For most efficient use, such viscosity should be between about 12,000 cps and 16,000 cps.

This slurry is “phase two”. In the formation thereof pursuant to the preparation of the complex, the temperature is important, that is between ambient and not more than about 30 degrees Centigrade, preferably between 22 degrees Centigrade and 25 degrees Centigrade. It should be noted that a sudden adverse rise in temperature of the reaction environment at this point could again mean that the aluminum starting material was not sufficiently pure.

Alternatively, though less desirably, the slurry can also be made “in situ” in the embodiment represented by FIG. 2. As shown in FIG. 2, the aluminum bar or rod is covered by HCL but is also partly submerged in the source of mercury. Optionally, the HCL needs not continue to cover the aluminum after oxide formation thereon is prevented or inhibited. A portion of the aluminum can be exposed above the surface. In either case, whether the HCL continues to cover the surface of the aluminum or not, a growth of some kind of complex occurs. This growth, itself, in this embodiment, is not the “phase two” slurry of this invention. The latter occurs in the is “in situ” treatment, either when the particles of the “growth”“fall off” into the acidic portion of the HCL bath to form the slurry as herein before described. In either case, the sequence has been followed of treating an oxide-free aluminum with mercury to change the structure of the aluminum and to effect as activation, and then contacting or continuing to contact said aluminum with HCL to cause the “phase two” slurry formation.
3. In the slurry-forming step, it has been found useful, in order to avoid undesirable heat from occurring, to position the aluminum bar or rod substantially equidistant from the sides and bottom of the vessel, which is essentially the same as, or grater than the diameter of the rod or bar, a cylindrical rod shape being preferred. It is of course possible to inhibit formation of undesirable heat without the above indicated special relationships, in this even, the avoidance of oxides as a consequence of overheating would have to be constantly monitored. IN this regard for example, the treated bare could be constantly removed, rewashed and reinserted and recoated with mercury.

The phase two slurry is quite acidic with a pH level of between about 3 and about 4. It also contains both hydrogen and oxygen and chlorine atoms probably in ionic form therein. The reason for this is that the phase one material has clathrate capabilities, i.e. it cant entrap or confine the hydrogen, oxygen and chlorine ions within the particles of the slurry.

While the aforesaid temperature gradients are important when forming the slurry preparatory to the subsequent formation of the complex. It should be noted that the slurry itself can also be formed using somewhat higher temperatures, on the order of up to 40 degrees centigrade, and also starting with aluminum of slightly less purity.

The next stage in the process of forming the final complex, i.e. stage three is to adjust the pH so that the chlorine defined within the said particles of the slurry becomes active; “active” have meaning potentially unstable but not to the extent that the chlorine is liberated as chlorine gas. In this regard, it is desirable that the pH level of the slurry ultimately reside at a pH of about 3.0+/−0.2. At this juncture, it could be noted that if the viscosity of the slurry is between about 12,000 and 16,000 cps, the slurry will contain between about 1.5 and about 3.0% aluminum suspended therein in elemental form.

The increase or decrease of the pH is accomplished by treating the phase two materials with a strong hydroxide such as NaOH or KOH in case of increase, and with HCL in case of decrease. The normality is not critical, but usually can be between about 2 and 3 Normal concentration. The increase or decreased pH slurry can be termed “phase three”.

The slurry is now ready to be applied as a decontaminating agent on selected objects.

Phase “four” consists of delivering and saturating soil contaminated with toxic substances with the said adjusted slurry, while the range is enormous, we will mention some basic materials in every day occurring contamination of the soil. Petroleum products, tar, various coal residues, arsenic, potassium cyanide, ammonia derivatives, chromium and many other pollutants, exceptions should be made for lead and light ethers with a specific gravity below 1.0, such as ligroin, petroleum ether etc.

### Application of the Deontaminant Slurry to the Soil

Depending on the amount of the toxic substances in the contaminated soil, a measured amount of “phase three” pH adjusted slurry, is distributed evenly on the surface of the contaminated area. Depending on the consistency of the soil, the slurry penetrates to the soil porosities and attacks the toxic compounds rendering them inactive. The activity of the slurry breaks down the molecules of the contaminant to the basic atoms, rendering them inert, and inactive. This process under normal climatic condition takes about 3.5-4 hours. However, it has to be noted, if the soil is less porous due to clayish layers it could take somewhat longer period of time in order to execute the breaking up the toxic molecules by the said pH adjusted and active slurry.
4. This invention can be further illustrated by the following examples. Unless otherwise indicated all percentages are by weight.

### 5. EXAMPLE 1—FORMATION OF THE SLURRY

6. 500 grams of aluminum rod, having not more than 0.1% impurities was placed in 36 inch long shallow glass vessel as exemplified by FIG. 1. At a temperature of 20 degrees Centigrade, the aluminum was contacted with 3N hydrochloric acid in amounts sufficient to cover the aluminum rod. Thereafter the aluminum rod was removed from the first HCl bath and immersed in a mercury bath for approximately 20 seconds under moist (about 30 percent relative humidity) air atmospheric conditions. There also being a layer of HCL covering the mercury bath. The mercury contacted aluminum ro was then reimmersed in a bath of 2N HCL. At this point, the rod was positioned equidistant from the sides and bottom of the vessel. A growth was observed on the immersed surface of aluminum on all sides thereof. The aluminum bar also begins to dissolve in the HCL bath.

Also immediately, a milky white cloud began to appear. After about * hours, slurry begins to be discernible. The temperature was kept below 30 degrees Centrigrade. The reaction continued until all of the aluminum bar was consumed. Before the bar was consumed, however the slurry became so thick the reaction was severely inhibited. This occurred after about 48 hours. This thick slurry was then removed and fresh HCL added. This was continued until the dissolution of the aluminum was completed. The slurry had a pH of 3.5. The pH of the slurry was then adjusted to 3.0+/−0.2 by increasing the hydrogen ion content by addition of HCL.

### EXAMPLE 2—APPLICATION OF THE SLURRY

An amount of 4000 gms. Of slurry of the “phase three” was placed in an open suitable acid resistant container. The pH of the slurry is adjusted to 4.5 with the addition of 3N KOH. While the reaction between the acidic slurry and the alkaline KOH was still active, it was distributed equally over the surface of an area of about 200 square feet of soil contaminated with potassium cyanide. The above aforementioned slurry, pH adjusted, penetrated slowly through the porous consistency of the soil. The decontamination process itself, last about 3.5 hours. Samples from different parts of the such treated area had been collected and examined through a Bausch and Lomb Gas Chromatography instrument. The such type executed analysis showed, that the toxic compound KCN has been broken up into elementary separate form of potassium nitrogen and carbon, rendering the toxic compound of KCN totally inert and nontoxic.

### Utility as a Decontaminating Agent

It is well known that the modern industrial age, has beside its enormous success in producing products that advance the state of knowledge and general quality of life, also has produced contamination of the air, water and soil.

The complex of this invention meets the need of decontamination of the soil from a whole array of toxic elements, compounds and complexes. It is very efficient and economical furthermore, it is nonreactive, nonpolluting and indifferent to ozone. It is applicable to an extremely broad range of industrial and commercial toxic waste and undesirable byproducts. Moreover, in use, the subject inventive material has controllable parameters within accepted temperature/products requirements as well as industry and government regulation. It is easily manageable, nontoxic, nonirritating, and totally safe for the environment.

1. A complex of decontaminating agent comprising activated silicon containing aluminum particles prepared by the steps of:
A) contacting aluminum metal containing at least trace amounts of silicon with an acid of the type which will remove oxide coating from and inhibit oxide formation thereon.
B) Simultaneously or thereafter contacting said aluminum with mercury or a source of mercury.
C) Immersing said mercury contacted aluminum metal in an acid bath containing halogen, at ambient temperature to not more than about 40 degrees Centigrade, whereby particles formed on the metal which on mixing with the acid bath form the slurry.
D) Adjusting the pH of the slurry between 4.5 and 5.
The composition according to claim 1) where in the acid of steps A) and C) is HCL.
A method of decontaminating regular soil which contains toxic substances which comprises:
Soaking said toxic containing soil with a suspension comprising activated silicon containing aluminum metal containing at least trace amounts of silicon with an acid of the type which will remove oxide and coating from and inhibit oxide formation thereon; simultaneously or thereafter contacting said aluminum with mercury or a source of mercury; immersing said mercury contacted aluminum metal in an acid bath at ambient temperature to not more than about 40 degrees centigrade, whereby particles formed on the metal which on mixing with the acid bath form the slurry form the slurry adjusting the pH of said slurry to 4.5-5.0.
Soaking the contaminated soil with the said suspension.
The method according to claim 3) wherein said materials are selected from the groups of toxins, both organic and inorganic.
